(19) United States
(12) Patent Application Publication
(10) Pub. No.: US 2014/0266957 A1
(43) Pub. Date: Sep. 18, 2014

(54) WIDE-ANGLE ANTENNA AND ARRAY ANTENNA

(71) Applicants: Furukawa Electric Co., Ltd., Tokyo (JP); Furukawa Automotive Systems Inc., Shiga (JP)

(72) Inventor: Daisuke INOUE, Tokyo (JP)

(73) Assignees: Furukawa Electric Co., Ltd., Tokyo (JP); Furukawa Automotive Systems Inc., Shiga (JP)

(21) Appl. No.: 14/292,137

(22) Filed: May 30, 2014

Related U.S. Application Data
(63) Continuation of application No. PCT/JP2012/082731, filed on Dec. 18, 2012.

(30) Foreign Application Priority Data
Feb. 16, 2012 (JP) 2012-031934

(51) Int. Cl. H01Q 9/04

(52) U.S. Cl. CPC H01Q 9/0407
USPC 343/843

(57) ABSTRACT

A robust wide-angle antenna and array antenna are provided that enable to obtain a gain not having a high peak and a null over a wide angle, and in which the deviation in radiation characteristics with respect to a dimensional change is small.

An array antenna 100 has a plurality of wide-angle antennas 110 arranged in a single row on a surface of one side of a substrate 120. The wide-angle antenna 110 is configured by placing one piece of a fed element 111 and two pieces of a non-fed element 112 on the substrate 120. By rendering the patch length L of the non-fed element 112 to be larger than 0.5 λg and is equal to or less than 0.75 λg, the amplitude ratio and phase difference are not affected by a change in the patch length L and wide band antenna characteristics can be obtained.

### TECHNICAL FIELD

The present invention relates to a wide-angle antenna applicable to equipment for emitting radio waves and an array antenna in which a plurality of pieces of the wide-angle antenna is arranged, more particularly to a wide-angle antenna and an array antenna suitable in applying to a radar device mounted on an automobile.

### BACKGROUND ART

In order to support safety drive of an automobile, development of devices for monitoring obstacles and the like (objects) existing around the automobile using radar has been promoted. As automobile-surroundings monitoring radar like this, LCA (Lane Change Assist) for supporting a lane change, BSD (Blind Spot Detection) for supporting detection of a blind spot, CTA (Cross Traffic Alert) giving an alarm when unexpectedly encountering a person, an oncoming car or the like, and the like are going to be put into practical use. Among automobile-surroundings monitoring radars, there is one that is demanded to detect an object within a substantially fan-shaped range composed of a certain angle range (for example, within a wide angle range of the order of −60° to +60° with respect to the center, being the front in the radiation direction).

On the other hand, in UWB radar and the like using radio waves in a wide band range, an allowable value with respect to, for example, EIRP (Equivalent Isotropic Radiated Power) is specified as a regulation with respect to transmitting radio waves. When the peak gain of radiation from an antenna is Gt (θmax), and the transmission power is Pt, EIRP is given as follows.

EIRP=Pt×Gt(θmax)

where θmax indicates an angle causing the power density to become the peak.

From the above equation, when the peak gain Gt (θmax) is high, the transmission power Pt is to be limited. Accordingly, in order to enhance the sensitivity of radar in a wide angle range, it is preferable to increase the transmission power Pt by lowering the peak gain Gt (θmax) and to transmit isotropic radio waves as much as possible.

The techniques for emitting radio waves in a wide angle are described in Patent Literatures 1, 2. In the Patent Literature 1, there is disclosed a patch-type antenna provided with a plane patch antenna 2 and a ground plate 1 as shown in FIG. 15. On the both sides of the plane patch antenna 2, there are placed two non-fed elements 4, which are not on the same level as the plane patch antenna 2, and enhancement of the gain in a side direction is to be achieved by that those two non-fed elements 4 act as wave directors.

Moreover, in Patent Literature 2, there is disclosed an array antenna that is formed on a dielectric 8 and is configured of a fed patch antenna 5 and non-fed patch antennas 6, 7 placed at least on the both sides in one direction of this patch antenna 5 as shown in FIG. 16. The directivity synthesis of the array antenna system is enabled by varying the resonance frequencies of the non-fed patch antennas 6, 7 to be different with the resonance frequency of the fed patch antenna 5. It is said that the flexibility of the directivity synthesis is enlarged by varying the phase of the excitation current, and disturbance in the directivity can also be prevented.

### CITATION LIST

### Patent Literature

Patent Literature 1: JP 2002-158534 A
Patent Literature 2: JP 09-246852 A

### SUMMARY OF INVENTION

### Technical Problem

However, in regard to the invention described in the Patent Literature 1, although angle-widening is enabled by placing the two non-fed elements 4 on the both sides of the plane patch antenna 2, there is a problem that the gain at the front in the radiation direction is lowered to cause a null to be formed. There is no description about a configuration for realizing an radiation pattern which is uniform as much as possible without forming a null in a predetermined wide angle range. Likewise, in the Patent Literature 2, although it is said that the flexibility of directivity synthesis is enhanced, there is a problem that a slight change in dimensions of the non-fed patch antennas 6, 7 may cause a variation in the directivity and the stability with respect to the deviation in dimensions and the like is lacked. In addition, since the change in dimensions of the non-fed patch antennas 6, 7 is accompanied by a change in the resonance frequency, the configuration is one with which it is difficult to achieve widening of the band.

The present invention was made in view of the above problems and an object of the present invention is to provide a robust wide-angle antenna and array antenna that enable to obtain a gain not having a high peak and a null over a wide angle, and in which the deviation in radiation characteristics with respect to a dimensional change is small.

### Solution to Problem

In order to solve the above problem, a wide-angle antenna according to a first aspect of the present invention includes: a substrate; a fed element placed on an radiation surface of the substrate; a non-fed element placed in a direction orthogonal to an excitation direction of the fed element; and a ground formed on a surface on an opposite side of the radiation surface of the substrate, wherein, when an intra-substrate effective wavelength in a working frequency is rendered to be λg, the non-fed element is such that an electrical length in the excitation direction is larger than 0.5 λg and is equal to or less than 0.75 λg, and another electrical length in a direction orthogonal to the excitation direction is equal to or more than 0.35 λg and is equal to or less than 0.65 λg; and excitation in the non-fed element has an amplitude ratio of 0.2 or less and a phase difference of 165° or less with respect to excitation in the fed element.

The wide-angle antenna according to another aspect of the present invention further includes a conductor layer that is formed in a periphery of the radiation surface of the substrate and is electrically connected with the ground.

In the wide-angle antenna according to another aspect of the present invention, two pieces of the non-fed element are placed so as to sandwich the fed element therebetween in a direction orthogonal to the excitation direction.

In the wide-angle antenna according to another aspect of the present invention, one piece of the non-fed element is placed on one side in a direction orthogonal to the excitation direction, and another side of the fed element in a direction orthogonal to the excitation direction is placed by being brought to close the conductor layer.

In the wide-angle antenna according to another aspect of the present invention, a normalized gain in a vertical direction of the fed element is equal to or more than −1 dB.

In the wide-angle antenna according to another aspect of the present invention, the fed element and the non-fed element are a micro-strip patch antenna formed on the substrate.

In the wide-angle antenna according to another aspect of the present invention, a distance between another side of the fed element and the conductor layer is equal to or less than 0.3 λg.

An array antenna according to the first aspect of the present invention includes two or more pieces of the wide-angle antenna described in any one of the first to sixth aspects in the excitation direction.

### Advantageous Effects of Invention

According to the present invention, it is possible to provide a robust wide-angle antenna and array antenna that enable to obtain a gain not having a high peak and a null at a wide angle, and in which the deviation in radiation characteristics with respect to a dimensional change is small.

### BRIEF DESCRIPTION OF DRAWINGS

FIGS. 1A and 1B are plan views showing the configuration of a wide-angle antenna and array antenna according to a first embodiment of the present invention.

FIGS. 2A and 2B are conceptual diagrams of radiation patterns for explaining the variation in radiation patterns due to arrangement of non-fed elements.

FIG. 3 is a graph showing an example of the radiation patterns of conventional array antennas.

FIG. 4 is a graph showing variations in the radiation pattern when the dimensions of a non-fed element are changed.

FIG. 5 is a graph showing variations in the normalized gain with respect to patch lengths at radiation angles 0°, ±60°.

FIGS. 6A and 6B are graphs showing variations in the amplitude ratio and phase difference with respect to patch lengths.

FIGS. 7A, 7B and 7C are graphs showing variations in the normalized gain with respect to patch lengths when the patch width is changed.

FIGS. 8A and 8B are graphs showing variations in the normalized gain with respect to patch widths at radiation angles 0°, ±60°.

FIGS. 9A, 9B and 9C are graphs showing variations in the normalized gain, amplitude ratio and phase difference with respect to patch lengths when the substrate thickness is changed.

FIG. 10 is a plan view showing the configuration of a wide-angle antenna and array antenna according to a second embodiment of the present invention.

FIGS. 11A, 11B, and 11C are plan views showing the configurations of the array antenna according to comparative examples.

FIGS. 12A and 12B are graphs for comparing the normalized gains of an array antenna of the second embodiment and the comparative examples.

FIG. 13 is a graph showing variations in the normalized gain when the distance d between a fed element and a conductor layer is changed.

FIGS. 14A, 14B and 14C are graphs showing variations in the normalized gain, amplitude ratio and phase difference with respect to patch lengths when the substrate thickness is changed.

FIG. 15 is a perspective view and a side view showing the configuration of a conventional antenna.

FIG. 16 is a plan view showing the configuration of another conventional antenna.

### DESCRIPTION OF EMBODIMENT

As to a wide-angle antenna and array antenna in a preferable embodiment of the present embodiment, an explanation will be given in detail with reference to the drawings. Respective constituent portions having an identical function are indicated by identical reference characters for simplifying illustration and explanation. The wide-angle antenna and array antenna of the present invention are applicable to equipment emitting radio wave, particularly suitable for usage for radar equipment mounted on an automobile. Note that with respect to the wavelength λ in a vacuum of a frequency used at radar equipment and antennas, λg is rendered to be an effective wavelength in a substrate, in which the relative permittivity ∈r of the substrate is taken into account, and is given as follows.

λg=λ/√∈r

### First Embodiment

A wide-angle antenna and array antenna according to the first embodiment of the present invention will be described below using FIGS. 1A and 1B. FIGS. 1A and 1B are plan views showing the configuration of a wide-angle antenna 110 and an array antenna 100 formed by arranging a plurality of pieces of the wide-angle antenna 110 of this embodiment. FIG. 1A is a plan view showing the configuration of the array antenna 100 and FIG. 1B is a plan view showing the configuration of the wide-angle antenna 110.

The array antenna 100 is configured by arranging the plurality of wide-angle antennas 110 in a single row on the surface (radiation surface) of one side of a substrate 120 and by providing a ground 121 on the surface of the other side of the substrate 120. In FIG. 1A, 6 pieces of the wide-angle antenna 110 are arranged in the excitation direction. Note that the array antenna 100 has a conductor layer 122 formed along the periphery on the radiation surface side of the substrate 120, and the conductor layer 122 is electrically connected to the ground 121 by means of a through hole or the like, which are not illustrated. The conductor layer 122 is not necessarily provided, but it may be positively used for avoiding unnecessary coupling caused by coexisting with a high-frequency circuit on the substrate, or for obtaining such an effect of adjusting an radiation pattern as described later.

The wide-angle antenna 110 shown in FIG. 1B is configured by arranging one piece of a fed element 111 and two pieces of a non-fed element 112 on the substrate 120. The two non-fed elements 112 are placed so as to sandwich the fed element 111 therebetween in a direction orthogonal to the excitation direction of the fed element 111. The fed element 111 and the non-fed elements 112 are rendered to be patch elements pattern-formed on the substrate 120, and the wide-angle antenna 110 is rendered to be a micro strip patch antenna. However, the wide-angle antenna 110 is not limited to the patch antenna, but is allowed to be, for example, a dipole antenna provided on the substrate. In the following description, the length of each of the fed element 111 and non-fed element 112 in the excitation direction is called as a patch length, and the length in a direction orthogonal to the excitation direction is called as a patch width. Note that the dimension described below is to represent not a physical length but an electrical length.

In the array antenna 100, the wide-angle antenna 110 has the two non-fed elements 112. By arranging the non-fed elements 112 so as to sandwich the fed element 111 from right and left, the peak of the gain of an radiation pattern 50 in the front direction appearing when not having the non-fed elements 112 is lowered and the gains in the wide-angle directions is increased as with an radiation pattern 51, as exemplified, for example, in FIG. 2A. FIGS. 2A and 2B show radiation patterns, where the horizontal axis and the vertical axis indicate an radiation angles (°) and a gain (dBi), respectively. The radiation angles on the horizontal axis are angles when the direction vertical to the substrate from the center of the array antenna (the front of the radiation direction) is rendered to be 0° on the vertical face in the longitudinal direction of the substrate (corresponding to the substrate 120 of this embodiment). An example of the normalized gain normalized such that the peak value of the gain becomes 0 dB is shown in FIG. 2B. By arranging the two non-fed elements 112, angle-widening of the radiation pattern can be achieved as with the radiation pattern 51′ shown in FIG. 2B.

Since the peak power is limited to a predetermined value or less in the specification with respect to EIRP, when the peak of an radiation pattern is reduced and angle widening thereof is achieved as exemplified in FIGS. 2A and 2B, it becomes possible to increase the peak power up to the specific value of EIRP by increasing a transmission power.

Although it has been known to use a non-fed element (parasitic element) for angle-widening of the directivity of an antenna, there has been a problem such that the gain at the front in the radiation direction of the antenna, i.e., in a direction perpendicular to the antenna face is lowered than the peak value and a null arises. As to a conventional array antenna in which two non-fed elements are arranged so as to sandwich a fed element therebetween as with the array antenna 100 of this embodiment shown in FIGS. 1A and 1B, the antenna characteristics will be described.

In a conventional array antenna, a non-fed element (corresponding to the non-fed element 112 of this embodiment) has been used with the patch length shorter than 0.5 λg for being used as a wave director. An example of the radiation pattern of a conventional array antenna is shown in FIG. 3. FIG. 3 shows radiation patterns, where the horizontal axis and the vertical axis indicate an radiation angles (°) and a normalized gain (dBi), respectively.

FIG. 3 shows the variation in the radiation pattern of the array antenna when the patch length (denoted as L) of the non-fed element is changed, using simulation results. The radiation patterns are shown when the patch length L of the non-fed element is rendered to be 0, 0.36 λg, 0.41 λg, 0.46 λg (indicated with characters 10 to 13, respectively) shorter than 0.5 λg, and is also rendered to be 0.52 λg (indicated with character 14) slightly longer than 0.5 λg. Note that the radiation pattern indicated with character 10 in the case of the patch length L=0 corresponds to the case in which any non-fed element is not provided.

From FIG. 3, the radiation pattern 10 when any non-fed element is not provided is such that the normalized gain becomes maximum at the front in the radiation direction the angle of which is 0°, and decreases by large amounts as the angle becomes large. Likewise, in regard to an radiation pattern 11 when the patch length L of the non-fed element is 0.36 λg, although the gain increases at angles wider than substantially ±50° as compared with the radiation pattern 10 when no non-fed element is provided, the gain decreases within the range of substantially ±50°; on this account, a favorable radiation pattern is not obtained. Regarding the radiation patterns 12, 13 when the patch length L of the non-fed element is further lengthened to be 0.41 λg, 0.46 λg, the gain increases on the wide angle side, but the gain on the front side in the radiation direction decreases. That is, the gain at the radiation angle 0° decreases, but the gain becomes maximum at an angle except 0° and a null is formed at the radiation angle 0°. It is not preferable as an radiation pattern that the null causing the gain to decrease on the front side in the radiation direction is formed like this.

In addition, when comparing the radiation patterns 11, 12, 13 when the patch lengths L are 0.36 λg, 0.41 λg, and 0.46 λg, a change in the patch length L only by 0.05 λg causes a significant variation. If the radiation pattern varies significantly due to a slight change in the patch length L like this, a slight deviation or the like in dimensions causes a variation in the radiation pattern. As antenna characteristics, it is required to have robust characteristics with which the radiation pattern does not vary by a large amount due to a slight change in the patch length L.

In regard to a conventional array antenna having a non-fed element the patch length of which is shortened less than 0.5 λg, there has been problems such that the radiation pattern varies by a large amount with respect to a change in the patch length L, the gain at the front in the radiation direction decreases, and the like. In contrast, regarding an radiation pattern 14 when the patch length L of the non-fed element is rendered to be 0.52 λg, being equal to or larger than 0.5 λg, there is not a drop of the gain at the front in the radiation direction, and a favorable radiation pattern in which the gain is high over a wide angle is also obtained. However, when the patch length L of the non-fed element is a length close to 0.5 λg, the directivity varies due to a slight change in the patch length, so it is not robust enough with respect to a dimensional change. It can also be said that it is not robust with respect to a design error and uneven fabrication. It is therefore difficult to realize a radar device that enables to obtain stable wide-angle radiation patterns.

In order to apply a wide-angle antenna to radar, which uses wide-band radio waves, like UWB (Ultra Wide Band) radar, it is necessary for the wide-angle antenna to have wide band characteristics. In wide band radar, stable antenna characteristics in a wide frequency band are demanded. However, it can be said that the conventional array antenna the characteristics of which vary only due to a slight change in the patch length of the non-fed element has, in other words, a large frequency characteristics and it is difficult to realize wide band characteristics. In wide band antennas, the antenna characteristics are required to be stable even when the physical length has changed. Accordingly, regarding wide band wide-angle antennas, it is required to have robust antenna characteristics particularly with respect to a physical variation like a patch length.

The wide-angle antenna 110 and array antenna 100 of this embodiment enable to obtain a high gain over a wide angle without causing a null at the front in the radiation direction, and have robust characteristics without varying the radiation pattern by a large amount with respect to a dimensional change. The gain at the front in the radiation direction is to be at least −1 dB or more.

The variations in the radiation patterns when the dimensions of the non-fed element 112 are changed in the array antenna 100 of this embodiment will be explained using the simulation results shown in FIG. 4. FIG. 4 shows radiation patterns, where the horizontal axis and the vertical axis indicate the radiation angles (°) and the normalized gains (dBi), respectively, and similar simulation results as those of FIG. 3 are used.

In FIG. 4, in addition to the radiation pattern 10 when the non-fed element 112 is not provided, and the radiation patterns 13, 14 when the patch length L of the non-fed element 112 is rendered to be 0.46 λg, 0.52 λg shown in FIG. 3, the radiation patterns when the patch length L of the non-fed element 112 is rendered to be 0.57 λg, 0.63 λg, 0.68 λg are indicated with characters 21, 22, 23, respectively.

From FIG. 4, when the patch length L of the non-fed element 112 is rendered to be larger than 0.5 λg, the normalized gain becomes equal to or more than −1 dB without forming a null at the radiation angle 0°, and stable radiation patterns are formed. The non-fed element 112 having the patch length L larger than 0.5 λg is able to adjust the directivity of the antenna as a reflector, and a high gain can thereby be obtained with stability over a wide angle.

The influence of the patch length L of the non-fed element 112 exerted on the directivity (radiation pattern) of the array antenna 100 will be explained further in detail below using FIG. 5. FIG. 5 is one that shows how each of the normalized gain at the radiation angle 0° and the normalized gains at the radiation angles −60°, +60° (indicated with characters 24, 25, 26, respectively) varies in accordance with the patch length L, in which the simulation results of FIG. 4 are used. In FIG. 5, it is known that, when the patch length L of the non-fed element 112 is smaller than 0.5 λg, the normalized gain significantly varies with respect to a change in the patch length L.

In contrast, it is shown that, when the patch length L of the non-fed element 112 is larger than 0.5 λg and is equal to or less than 0.75 λg (the range indicated with arrow 27), the normalized gain hardly varies or gently varies. Within the above range of the patch length L, the normalized gain gently varies at either radiation angle of 0°, ±60°, and it is therefore known that the radiation pattern gently varies within the range of −60° to +60° with respect to a change in the patch length L.

The radiation patterns shown in FIG. 4 are determined by the radiation of the fed element 111 and non-fed element 112, particularly by the amplitude ratio and phase difference of the non-fed element with respect to the fed element. Then, it will be explained using FIGS. 6A, 6B how the amplitude ratio and phase difference vary due to a change in the patch length L of the non-fed element 112. FIG. 6A shows the variation in the amplitude ratio with respect to the patch length L, and FIG. 6B shows the variation in the phase difference with respect to the patch length L, respectively using the results of current characteristics excited by the patch in simulations.

As shown in FIG. 6A, the amplitude ratio significantly varies in accordance with a change in the patch length L when the patch length L is smaller than 0.5 λg. In contrast, when the patch length L is larger than 0.5 λg, the amplitude ratio gently varies at the level equal to or less than 0.2. Likewise, in FIG. 6B, the phase difference varies in the range less than 180° when the patch length L is larger than 0.5 λg, particularly gently varies in the range equal to or less than 165°, as opposed to that the phase difference significantly varies when the patch length L is smaller than 0.5 λg. Particularly, by rendering the patch length L to be larger than 0.5 λg and equal to or less than 0.75 λg, it becomes possible that the amplitude ratio and phase difference are not greatly affected by a change in the patch length L, and wide band antenna characteristics can be obtained.

The variation in the radiation pattern shown in FIG. 4 is the simulation results when only the patch length has been changed with the patch width W fixed at 0.5 λg. Next, in order to see the influence of the patch width W exerted on the radiation pattern, the variation in the radiation pattern when the patch length L is changed at different patch widths W will be explained. As the variation in the radiation pattern, variations in the normalized gain with respect to the patch length L when the radiation angle is 0° and is ±60° are shown in FIGS. 7A, 7B, 7C as with FIG. 5. The same one as the simulation result in FIG. 5 when the patch width W has been rendered to be 0.5 λg is represented in FIG. 7B, and the simulation result when the patch width W has been rendered to be shorter than 0.5 λg and the simulation result when the patch width W has been rendered to be longer than 0.5 λg are shown in FIG. 7A and FIG. 7C, respectively.

In regard to the variation in the normalized gain shown in FIG. 7A when the patch width W is rendered to be 0.3 λg, the normalized gain in the frontal direction the radiation angle of which is 0° hardly varies when the patch length L is changed in a range lager than 0.5×. In contrast, at the radiation angles of ±60°, the normalized gain decreases in accordance with the patch length L. From this, it is known that it is difficult to obtain stable characteristics in a wide angle direction with respect to the deviation of the patch length L when the patch width W is rendered to be 0.3 λg, being shorter than 0.5 λg.

In regard to the variation in the normalized gain shown in FIG. 7C when the patch width W is rendered to be 0.67 λg, an another resonant mode arises at a predetermined patch length longer than 0.5 λg, and the range of the patch length L in which a stable gain is obtained in a wide angle range is limited. Moreover, it is known that, as the patch length L is lengthened to approach the predetermined patch length at which the another resonant mode arises, the normalized gain at the radiation angle 0° decreases and a null arises. Like this, it is indicated that it is also difficult to obtain stable characteristics in a wide angle direction with respect to the deviation in the patch length L when the patch width W is rendered to be 0.67 λg, being longer than 0.5 μg.

Graphs showing variations in the normalized gain with respect to the patch width are shown in FIGS. 8A and 8B, where the horizontal axis indicates patch widths W. FIG. 8A shows the simulation results when the patch width W is changed, regarding the normalized gain in the frontal direction the radiation angle of which is 0°, and FIG. 8B shows the simulation results when the patch width W is changed, regarding the normalized gain at radiation angles of ±60°. In addition, the normalized gains when the patch length L is rendered to be 0.46 λg (character 13), 0.52 λg (character 14), 0.57 λg (character 21), and 0.63 λg (character 22) are also shown. From FIG. 8A, it is known that, regarding the normalized gain in the frontal direction, generation of the another resonant mode is avoided as described above when the patch width W is equal to or less than 0.65 λg, and such characteristics are obtained that variations due to the patch length L are relatively small and are thereby stable. Likewise, from FIG. 8B, it is known that, regarding the normalized gain at radiation angles of ±60°, when the patch width W is equal to or larger than 0.35 λg, such characteristics are obtained that variations due to the deviation in the patch length L are relatively small and are thereby stable.

From the above results, it is known that the influence of the deviation in the patch length L on the radiation pattern can be lessened by rendering the patch width W of the non-fed element 112 to be equal to 0.35 λg or more and equal to 0.65 λg or less, and stable gains can be obtained in a wide angle range of the order of ±60°. By rendering the patch width W to be a value close to 0.5 λg, the influence of a change in the patch length L onto the radiation pattern is lessened and stable wide band characteristics with respect to a change in the frequency can be obtained.

Next, the influence of the thickness of the substrate 120, on which the fed element 111 and non-fed elements 112 are formed, on the radiation pattern of the array antenna 100 will be described. The simulation results described above are all based on the thickness of the substrate 120 of 0.16 λg. In contrast, the variation in the normalized gain with respect to the patch length L when the thickness of the substrate 120 is thinned is shown in FIGS. 9A, 9B and 9C. Here, the thickness of the substrate 120 is rendered to be 0.05 λg. FIG. 9A shows the variation in the normalized gain with respect to the patch length L when the radiation angle is 0° and is ±60° as with FIG. 5, and FIGS. 9B and 9C show the variation in the amplitude ratio with respect to the patch length L and the variation in the phase difference with respect to the patch length L, respectively, as with FIGS. 6A and 6B.

From FIG. 9A, the normalized gain varies significantly in accordance with a change in the patch length L when the patch length L is smaller than 0.5 λg. In contrast, it is known that, when the patch length L is larger than 0.5 λg, the amplitude ratio is equal to or less than 0.2 as shown in FIG. 9B and the phase difference is in a range smaller than 180° as shown in FIG. 9C, particularly when the phase difference is equal to or less than 165°, the amplitude ratio and the phase difference gently vary; as the result, the variation in the normalized gain is small with respect to a change in the patch length L and is stabilized.

As with the above description, in order to cause the array antenna 100 to form a wide angle radiation pattern and to have wide band characteristics, it may be better to render the patch length of the non-fed elements 112, being an electrical length in the excitation direction, to be longer than 0.5 λg and equal to or less than 0.75 λg; to render the patch width, being an electrical length in a direction orthogonal to the excitation direction, to be equal to or more than 0.35 λg and equal to or less than 0.65 λg; and further to render the amplitude ratio and phase difference of excitation in the non-fed element 112 with respect to excitation in the fed element 111 to be equal to or less than 0.2 and equal to or less than 165°, respectively. According to this embodiment, it is possible to provide a robust wide-angle antenna and array antenna that enable to cause the normalized gain at the front in the radiation direction to be equal to or more than −1 dB without forming a null, to obtain radiation patterns having a high gain in a wide angle range, and to provide antenna characteristics stable with respect to deviation in dimensions of the antenna elements.

### Second Embodiment

The second embodiment of the wide-angle antenna and array antenna of the present invention will be described below using FIG. 10. FIG. 10 is a plan view showing the configuration of a wide-angle antenna 210 of the second embodiment, and an array antenna 200 formed by arranging a plurality of pieces of the wide-angle antenna 210. The wide-angle antenna 210 of this embodiment has a non-fed element 112 arranged only on one side of a fed element 111 in a direction orthogonal to the excitation direction. In addition, a conductor layer 222 is formed along the periphery on the radiation surface side of a substrate 220, and the other side of the fed element 111, where the non-fed element 112 is not placed, is brought to close to the conductor layer 222. The conductor layer 222 is electrically connected to a ground 121, which is formed on the face of the substrate 220 on the opposite side of the radiation surface, by means of a through hole, which is not illustrated, and can be formed through ordinary pattern forming at a low cost.

In regard to the array antenna 100 of the first embodiment, it was necessary to lengthen the width of the substrate 120 (the length in a direction orthogonal to the excitation direction) in order to arrange the two non-fed elements 112 on the both sides of the fed element 111. For that reason, the area of the substrate 120 for arranging the wide-angle antennas 110 (the occupation area of the wide-angle antennas 110) becomes large. In contrast, in regard to the array antenna 200 of the this embodiment, it is enabled to lessen the area of the substrate 220 for arranging the wide-angle antennas 210 (the occupation area of the wide-angle antennas 210) by arranging the non-fed element 112 only on one side of the fed element 111 and also by bringing the other side, where the non-fed element 112 is not placed, close to the conductor layer 222. In the array antenna 200 of the this embodiment, the area of the substrate 220 is lessened as well as angle widening of the radiation pattern is achieved as with the array antenna 100 of the first embodiment.

Here, comparative examples of the array antenna having different configurations depending on presence or absence of the non-fed element 112 are shown in FIGS. 11A, 11B and 11C, and the technical features taken for achieving the angle widening in the array antenna 200 and wide-angle antenna 210 of this embodiment will be described. FIG. 11A shows the configuration of an array antenna 301 of a first comparative example, which has the same antenna occupation area as that of the array antenna 100 of the first embodiment and does not have the non-fed element 112, and FIG. 11B shows the configuration of an array antenna 302 of a second comparative example, which has the same antenna occupation area as that of the array antenna 100 of the first embodiment and has the non-fed element 112 only on one side.

In addition, FIG. 11C shows the configuration of an array antenna 303 of a third comparative example, which has an antenna occupation area lessened as with the array antenna 200 of the second embodiment and does not have the non-fed element 112. When compared with the array antenna 200 of the second embodiment, the array antenna 303 of the third comparative example is different in the point of not having the non-fed element 112 on one side of the fed element 111, and has the identical configuration in the point of lessening the area of the substrate 220 by bringing the other side close to the conductor layer 222.

Figures in which the radiation pattern of the array antenna 200 of this embodiment is compared with radiation patterns of the first to third comparative examples are shown in FIGS. 12A and 12B. FIG. 12A shows radiation patterns, where the horizontal axis indicates the radiation angles, and FIG. 12B shows a comparison of the normalized gains when the radiation angle is 0° and is ±60°. In FIG. 12A, character 30 indicates the radiation pattern of the array antenna 200 of this embodiment, and characters 31 to 33 indicate the radiation patterns of the first to third comparative examples, respectively. In addition, in FIG. 12B, character 34 indicates the normalized gain at the radiation angle of 0°, and characters 35, 36 indicate the normalized gains at +60°, −60°, respectively.

From FIG. 12A, regarding an radiation pattern 31 of the first comparative example 301, in which the non-fed element 112 is not provided and the area of the substrate is large, the normalized gains at wide angles cannot be raised and angle widening is not achieved. Likewise, regarding an radiation pattern 32 of the second comparative example 302, in which the non-fed element 112 is provided only on one side and the area of the substrate is large, although angle widening is achieved, such an offset that the gain peak deviates from the radiation angle of 0° is seen because the non-fed element 112 is placed only on one side. Further, regarding the radiation pattern of the third comparative example 303, in which the non-fed element 112 is not placed on one side of the fed element 111 and the other side is brought to close to the conductor layer 222, an offset that the gain peak deviates from the radiation angle of 0° to the opposite side with respect to the second comparative example 302 is seen in addition to that angle widening is not achieved.

In contrast, in the array antenna 200 of this embodiment, by bringing the other side of the fed element 111 close to the conductor layer 222 as well as arranging the non-fed element 112 on one side of the fed element 111, any offset of the gain peak does not arise as well as angle widening of the radiation pattern 30 is achieved.

In FIG. 12B, the normalized gains in wide-angle directions) (±60° are low in the first comparative example 301 and third comparative example 303 not having the non-fed element 112, and are high in the second comparative example 302 and in the array antenna 200 of the second embodiment having the non-fed element 112 only on one side. From this, it is known that angle widening has been achieved in the second comparative example 302 and also in the array antenna 200 of the second embodiment. However, in the second comparative example 302, the normalized gain at the radiation angle of +60° and the normalized gain at the radiation angle of −60° are considerably different to each other. This is due to that an offset arises at the gain peak. In contrast, in the array antenna 200 of this embodiment, it is known that the normalized gain at the radiation angle of +60° and the normalized gain at the radiation angle of −60° approximately coincide with each other, and any offset does not arise.

In this embodiment, by bringing the conductor layer 222 close to the other side of the fed element 111 instead of placing the non-fed element 112, a robust wide-angle antenna 210 and array antenna 200 are realized that enable to obtain a stable radiation pattern with respect to a change in the patch length of the non-fed element 112 similarly as with the first embodiment as well as a high gain over a wide angle is obtained. Note that, although there exist various techniques of adjusting the radiation pattern by conductor loading, one of merits here is to be able to form at a low cost in ordinary substrate fabrication.

In the array antenna 200 and wide-angle antennas 210 of this embodiment shown in FIG. 10, when the distance between the other side of the fed element 111 and the conductor layer 222 is rendered to be d, the variations in the normalized gain at radiation angles of 0°, −60°, +60° when d is changed are shown in FIG. 13 (respectively indicated with characters 34, 35, 36). From FIG. 13, while the normalized gains at ±60° are substantially equalized and stable when the distance d is equal to or less than 0.3 λg, the difference of the normalized gains at +60° and −60° becomes enlarged as the distance d becomes larger than 0.3 λg. From this, it is preferable that the distance d between the other side of the fed element 111 and the conductor layer 222 is rendered to be equal to or less than 0.3 λg.

The variations in the normalized gain with respect to patch lengths L in the array antenna 200 and wide-angle antennas 210 of this embodiment are shown in FIGS. 14A, 14B and 14C. FIG. 14A shows the variation in the normalized gain with respect to the patch length L at the radiation angles of 0°, −60°, +60° (respectively indicated with characters 34, 35, 36) as with FIG. 9A, and FIGS. 14B and 14C show the variation in the amplitude ratio with respect to the patch length L and the variation in the phase difference with respect to the patch length L, respectively, as with FIGS. 9B and 9C. Note that, in this example, the thickness of the substrate 220 is rendered to be 0.16 λg, and the patch width W is rendered to be 0.5 λg.

From FIG. 14A, it is known that the variation in the normalized gain is small and stable with respect to a change in the patch length L when the patch length L is larger than substantially 0.5 λg and is equal to or less than 0.75 λg. When the normalized gain is stable at the patch length L being larger than 0.5 λg and equal to or less than 0.75 λg, the amplitude ratio gently varies at 0.2 or less as shown in FIG. 14B. Likewise, the phase difference varies in the range smaller than 180° as shown in FIG. 14C, when phase difference is equal to or less than 165°, a particularly favorable gain is obtained.

Note that the description in this embodiment presents an example of the wide-angle antenna according to the present invention, and is not limited thereto. In regard to the detailed configuration, specified operation, and the like of the wide-angle antenna in this embodiment, it is possible to change appropriately within the scope not departing from the spirit of the present invention.

### REFERENCE SIGNS LIST

100, 200 Array antenna
110, 210 Wide-angle antenna
111 Fed element
112 Non-fed element
120, 220 Substrate
121 Ground
122, 222 Conductor layer

1. A wide-angle antenna, comprising:
a substrate;
a fed element placed on an radiation surface of the substrate;
a non-fed element placed in a direction orthogonal to an excitation direction of the fed element; and
a ground formed on a surface on an opposite side of the radiation surface of the substrate,
wherein, when an intra-substrate effective wavelength in a working frequency is rendered to be λg,
the non-fed element is such that an electrical length in the excitation direction is larger than 0.5 λg and is equal to or less than 0.75 λg, and an electrical length in a direction orthogonal to the excitation direction is equal to or more than 0.35 λg and is equal to or less than 0.65 λg; and
excitation in the non-fed element has an amplitude ratio of 0.2 or less and a phase difference of 165° or less with respect to excitation in the fed element.

2. The wide-angle antenna according to claim 1, further comprising a conductor layer that is formed in a periphery of the radiation surface of the substrate and is electrically connected with the ground.

3. The wide-angle antenna according to claim 1, wherein two pieces of the non-fed element are placed so as to sandwich the fed element therebetween in a direction orthogonal to the excitation direction.

4. The wide-angle antenna according to claim 2, wherein one piece of the non-fed element is placed on one side in a direction orthogonal to the excitation direction, and
another side of the fed element in a direction orthogonal to the excitation direction is placed by being brought close to the conductor layer.

5. The wide-angle antenna according to claim 1, wherein a normalized gain in a vertical direction of the fed element is equal to or more than −1 dB.

6. The wide-angle antenna according to claim 1, wherein the fed element and the non-fed element are a micro-strip patch antenna formed on the substrate.

7. The wide-angle antenna according to claim 4, wherein a distance between another side of the fed element and the conductor layer is equal to or less than 0.3 λg.

8. An array antenna, comprising two or more pieces of the wide-angle antenna according to claim 1 in the excitation direction.
